(19) United States
(12) Patent Application Publication
(10) Pub. No.: US 2007/0044657 A1
(43) Pub. Date: Mar. 1, 2007

(54) Fuel cell systems and methods for passively increasing hydrogen recovery through vacuum-assisted pressure swing adsorption

(76) Inventors: Arne LaVen, Bend, OR (US); Curtiss Renn, Bend, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/219,169

(22) Filed: Sep. 1, 2005

(51) Int. Cl. B01D 53/02

(52) U.S. Cl. 95/96

(57) ABSTRACT

PSA assemblies with at least one energy recovery assembly, as well as hydrogen-generation assemblies and/or fuel cell systems containing the same, and methods of operating the same. The energy recovery assemblies are configured to recover mechanical energy from the product hydrogen stream and to apply the recovered mechanical energy to one or more components of the PSA assembly, the hydrogen-generation assembly, and/or the energy producing system. In some embodiments, the energy recovery assembly includes a gas motor configured to recover mechanical energy from the product hydrogen stream produced by the PSA assembly. In some embodiments, the gas motor operates among a plurality of operating states based, at least in part, on the pressure of the product hydrogen stream. In some embodiments, the energy recovery assembly is configured to apply the recovered mechanical energy to at least a vacuum pump.

### FIELD OF THE DISCLOSURE

The present disclosure is directed generally to hydrogen-generation assemblies that include pressure swing adsorption assemblies, and more particularly to systems and methods for recovering energy from pressure swing adsorption assemblies.

### BACKGROUND OF THE DISCLOSURE

A hydrogen-generation assembly is an assembly that includes a fuel processing system that is adapted to convert one or more feedstocks into a product stream containing hydrogen gas as a majority component. The produced hydrogen gas may be used in a variety of applications. One such application is energy production, such as in electrochemical fuel cells. An electrochemical fuel cell is a device that converts a fuel and an oxidant to electricity, a reaction product, and heat. For example, fuel cells may convert hydrogen and oxygen into water and electricity. In such fuel cells, the hydrogen is the fuel, the oxygen is the oxidant, and the water is the reaction product. Fuel cells typically require high purity hydrogen gas to prevent the fuel cells from being damaged during use. The product stream from the fuel processing system of a hydrogen-generation assembly may contain impurities, illustrative examples of which include one or more of carbon monoxide, carbon dioxide, methane, unreacted feedstock, and water. Therefore, there is a need in many conventional fuel cell systems to include suitable structure for removing impurities from the impure hydrogen stream produced in the fuel processing system.

A pressure swing adsorption (PSA) process is an example of a mechanism that may be used to remove impurities from an impure hydrogen gas stream by selective adsorption of one or more of the impurities present in the impure hydrogen stream. The adsorbed impurities can be subsequently desorbed and removed from the PSA assembly. PSA is a pressure-driven separation process that utilizes a plurality of adsorbent beds. The beds are cycled through a series of steps, such as pressurization, separation (adsorption), depressurization (desorption), and purge steps to selectively remove impurities from the hydrogen gas and then desorb the impurities. The PSA assembly produces a product hydrogen stream with substantially reduced impurities.

The PSA process may include streams and/or steps in which energy may be recovered and/or reused. For example, the pressure of the product hydrogen stream from the PSA assembly may need to be regulated before that product stream is used in various applications, such as fuel for electrochemical fuel cells. Regulation of pressure typically involves the loss of mechanical energy associated with the product hydrogen stream, which may otherwise be recovered and/or reused.

### SUMMARY OF THE DISCLOSURE

The present disclosure is directed to PSA assemblies with at least one energy recovery assembly, as well as to hydrogen-generation assemblies and/or fuel cell systems containing the same, and to methods of operating the same. The PSA assemblies include at least one adsorbent bed, and typically a plurality of adsorbent beds, that include an adsorbent region including adsorbent adapted to remove impurities from a mixed gas stream containing hydrogen gas as a majority component and other gases. The mixed gas stream may be produced by a hydrogen-producing region of a fuel processing system, and the PSA assembly may produce a product hydrogen stream that is consumed by a fuel cell stack to provide a fuel cell system that produces electrical power. The energy recovery assemblies are configured to recover mechanical energy from the product hydrogen stream and to apply the recovered mechanical energy to one or more components of the PSA assembly, the hydrogen-generation assembly, and/or the energy producing system. In some embodiments, the energy recovery assembly includes a gas motor configured to recover mechanical energy from the product hydrogen stream produced by the PSA assembly. In some embodiments, the gas motor is adapted to transition between a plurality of operating states based, at least in part, on the pressure of the product hydrogen stream. In some embodiments, the hydrogen-generation assembly is configured to produce the product hydrogen stream regardless of the operating state of the gas motor. In some embodiments, the energy recovery assembly includes a pressure regulator configured to regulate the pressure of the product hydrogen stream regardless of the operating state of the gas motor. In some embodiments, the energy recovery assembly is configured to apply the recovered mechanical energy to at least a vacuum pump that is configured to generate a purging vacuum and/or a purging vacuum supply for a purge system of the pressure swing adsorption assembly. In some embodiments, the purge system is configured to selectively purge the one or more adsorbent beds of the PSA assembly regardless of the purging vacuum and/or purging vacuum supply generated by the vacuum pump.

### BRIEF DESCRIPTION OF THE DRAWINGS

FIG. 1 is a schematic view of an illustrative example of an energy producing and consuming assembly that includes a hydrogen-generation assembly with an associated feedstock delivery system and a fuel processing system, as well as a fuel cell stack, and an energy-consuming device.

FIG. 2 is a schematic view of a hydrogen-producing assembly in the form of a steam reformer adapted to produce a reformate stream containing hydrogen gas and other gases from water and at least one carbon-containing feedstock.

FIG. 3 is a schematic view of a fuel cell, such as may form part of a fuel cell stack used with a hydrogen-generation assembly according to the present disclosure.

FIG. 4 is a schematic view of an example of an energy-producing system with an energy recovery assembly according to the present disclosure.

FIG. 5 is a schematic view of a pressure swing adsorption assembly that may be used according to the present disclosure.

FIG. 6 is a schematic cross-sectional view of an illustrative example of an adsorbent bed that may be used with PSA assemblies according to the present disclosure.

FIG. 7 is a schematic cross-sectional view of another illustrative example of an adsorbent bed that may be used with PSA assemblies according to the present disclosure.

FIG. 8 is a schematic cross-sectional view of another illustrative example of an adsorbent bed that may be used with PSA assemblies according to the present disclosure.

FIG. 9 is a schematic cross-sectional view of the adsorbent bed of FIG. 7 with a mass transfer zone being schematically indicated.

FIG. 10 is a schematic cross-sectional view of the adsorbent bed of FIG. 9 with the mass transfer zone moved along the adsorbent region of the bed toward a distal, or product, end of the adsorbent region.

FIG. 11 is a schematic view of another illustrative example of a pressure swing adsorption assembly with an energy recovery assembly according to the present disclosure.

FIG. 12 is a schematic view of another example of a pressure swing adsorption assembly with an energy recovery assembly according to the present disclosure.

FIG. 13 is a graph depicting expected product recovery as a function of the pressure of the mixed gas stream delivered to a PSA assembly and the pressure of the byproduct stream from the PSA assembly.

FIG. 14 is a schematic view of another example of an energy recovery assembly that may be used with a pressure swing adsorption assembly according to the present disclosure.

FIG. 15 is a schematic view of another example of an energy recovery assembly that may be used with a pressure swing adsorption assembly according to the present disclosure.

### DETAILED DESCRIPTION AND BEST MODE OF THE DISCLOSURE

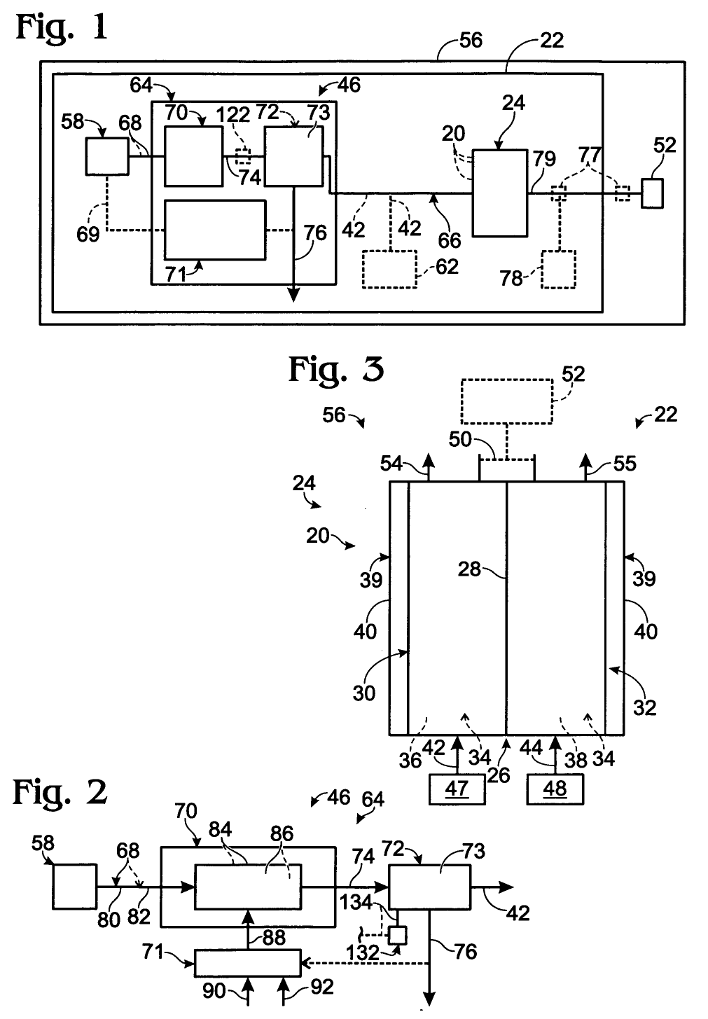

FIG. 1 illustrates schematically an example of an energy producing and consuming assembly 56. The energy producing and consuming assembly 56 includes an energy-producing system 22 and at least one energy-consuming device 52 that is adapted to exert an applied load on the energy-producing system 22. In the illustrated example, the energy-producing system 22 includes a fuel cell stack 24 and a hydrogen-generation assembly 46. More than one of any of the illustrated components may be used without departing from the scope of the present disclosure. The energy-producing system may include additional components that are not specifically illustrated in the schematic figures, such as air delivery systems, heat exchangers, sensors, controllers, flow-regulating devices, fuel and/or feedstock delivery assemblies, heating assemblies, cooling assemblies, and the like. System 22 may also be referred to as a fuel cell system.

As discussed in more detail herein, hydrogen-generation assemblies and/or fuel cell systems according to the present disclosure include a separation assembly that includes at least one pressure swing adsorption (PSA) assembly that is adapted to increase the purity of the hydrogen gas that is produced in the hydrogen-generation assembly and/or consumed in the fuel cell stack. In a PSA process, gaseous impurities are removed from a stream containing hydrogen gas. PSA is based on the principle that certain gases, under the proper conditions of temperature and pressure, will be adsorbed onto an adsorbent material more strongly than other gases. These impurities may thereafter be desorbed and removed, such as in the form of a byproduct stream. The success of using PSA for hydrogen purification is due to the relatively strong adsorption of common impurity gases (such as, but not limited to, CO, CO₂, hydrocarbons including CH₄, and N₂) on the adsorbent material. Hydrogen adsorbs only very weakly and so hydrogen passes through the adsorbent bed while the impurities are retained on the adsorbent material.

As discussed in more detail herein, a PSA process typically involves repeated, or cyclical, application of at least pressurization, separation (adsorption), depressurization (desorption), and purge steps, or processes, to selectively remove impurities from the hydrogen gas and then desorb the impurities. Accordingly, the PSA process may be described as being adapted to repeatedly enable a PSA cycle of steps, or stages, such as the above-described steps. The degree of separation is affected by the pressure difference between the pressure of the mixed gas stream delivered to the PSA assembly and the pressure of the byproduct (impurity) stream purged or otherwise exhausted from the PSA assembly. Accordingly, the desorption and/or purge steps typically will include reducing the pressure within the portion of the PSA assembly containing the adsorbed gases, and optionally may even include drawing a vacuum (i.e., reducing the pressure to less than atmospheric or ambient pressure) on that portion of the assembly. Similarly, increasing the feed pressure of the mixed gas stream to the adsorbent regions of the PSA assembly may beneficially affect the degree of separation during the adsorption step.

As illustrated schematically in FIG. 1, the hydrogen-generation assembly 46 includes at least a fuel processing system 64 and a feedstock delivery system 58, as well as the associated fluid conduits interconnecting various components of the system. As used herein, the term “hydrogen-generation assembly” may be used to refer to the fuel processing system 64 and associated components of the energy-producing system, such as feedstock delivery systems 58, heating assemblies, separation regions or devices, air delivery systems, fuel delivery systems, fluid conduits, heat exchangers, cooling assemblies, sensor assemblies, flow regulators, controllers, etc. All of these illustrative components are not required to be included in any hydrogen-generation assembly or used with any fuel processing system according to the present disclosure. Similarly, other components may be included or used as part of the hydrogen-generation assembly.

Regardless of its construction or components, the feedstock delivery system 58 is adapted to deliver to fuel processing system 64 one or more feedstocks via one or more streams, which may be referred to generally as feedstock supply stream(s) 68. In the following discussion, reference may be made only to a single feedstock supply stream, but is within the scope of the present disclosure that two or more such streams, of the same or different composition, may be used. In some embodiments, air may be supplied to the fuel processing system 64 via a blower, fan, compressor or other suitable air delivery system, and/or a water stream may be delivered from a separate water source.

Fuel processing system 64 includes any suitable device(s) and/or structure(s) that are configured to produce hydrogen gas from the feedstock supply stream(s) 68. As schematically illustrated in FIG. 1, the fuel processing system 64 includes a hydrogen-producing region 70. Accordingly, fuel processing system 64 may be described as including a hydrogen-producing region 70 that is adapted to produce a hydrogen-rich mixed gas stream 74 that includes hydrogen gas as a majority component from the feedstock supply stream(s) delivered to the hydrogen-producing region. While stream 74 contains hydrogen gas as its majority component, it also contains other gases, and as such may be referred to as a mixed gas stream that contains hydrogen gas and other gases. Illustrative, non-exclusive examples of these other gases, or impurities, include one or more of such illustrative impurities as carbon monoxide, carbon dioxide, water, methane, and unreacted feedstock.

Illustrative examples of suitable mechanisms for producing hydrogen gas from feedstock supply stream 68 include steam reforming and autothermal reforming, in which reforming catalysts are used to produce hydrogen gas from a feedstock supply stream 68 containing water and at least one carbon-containing feedstock. Other examples of suitable mechanisms for producing hydrogen gas include pyrolysis and catalytic partial oxidation of a carbon-containing feedstock, in which case the feedstock supply stream 68 does not contain water. Still another suitable mechanism for producing hydrogen gas is electrolysis, in which case the feedstock is water. Illustrative examples of suitable carbon-containing feedstocks include at least one hydrocarbon or alcohol. Illustrative examples of suitable hydrocarbons include methane, propane, natural gas, diesel, kerosene, gasoline and the like. Illustrative examples of suitable alcohols include methanol, ethanol, and polyols, such as ethylene glycol and propylene glycol.

The hydrogen-generation assembly 46 may utilize more than a single hydrogen-producing mechanism in the hydrogen-producing region 70 and may include more than one hydrogen-producing region. Each of these mechanisms is driven by, and results in, different thermodynamic balances in the hydrogen-generation assembly 46. Accordingly, the hydrogen-generation assembly 46 may further include a temperature modulating assembly 71, such as a heating assembly and/or a cooling assembly. The temperature modulating assembly 71 may be configured as part of the fuel processing system 64 or may be an external component that is in thermal and/or fluid communication with the hydrogen-producing region 70. The temperature modulating assembly 71 may consume a fuel stream, such as to generate heat. While not required in all embodiments of the present disclosure, the fuel stream may be delivered from the feedstock delivery system. For example, and as indicated in dashed lines in FIG. 1, this fuel, or feedstock, may be received from the feedstock delivery system 58 via a fuel supply stream 69. The fuel supply stream 69 may include combustible fuel or, alternatively, may include fluids to facilitate cooling. The temperature modulating assembly 71 may also receive some or all of its feedstock from other sources or supply systems, such as from additional storage tanks. It may also receive the air stream from any suitable source, including the environment within which the assembly is used. Blowers, fans, and/or compressors may be used to provide the air stream, but this is not required for all embodiments.

The temperature modulating assembly 71 may include one or more heat exchangers, burners, combustion systems, and other such devices for supplying heat to regions of the fuel processing system and/or other portions of assembly 56. Depending on the configuration of the hydrogen-generation assembly 46, the temperature modulating assembly 71 may also, or alternatively, include heat exchangers, fans, blowers, cooling systems, and other such devices for cooling regions of the fuel processing system 64 or other portions of assembly 56. For example, when the fuel processing system 64 is configured with a hydrogen-producing region 70 based on steam reforming or another endothermic reaction, the temperature modulating assembly 71 may include systems for supplying heat to maintain the temperature of the hydrogen-producing region 70 and the other components within a selected hydrogen-producing temperature range, such as above a threshold hydrogen-producing temperature.

When the fuel processing system is configured with a hydrogen-producing region 70 based on catalytic partial oxidation or another exothermic reaction, the temperature modulating assembly 71 may include systems for removing heat, i.e., supplying cooling, to maintain the temperature of the fuel processing system within a selected hydrogen-producing temperature range, such as below a threshold hydrogen-producing temperature. As used herein, the term “heating assembly” is used to refer generally to temperature modulating assemblies that are configured to supply heat or otherwise increase the temperature of all or selected regions of the fuel processing system. As used herein, the term “cooling assembly” is used to refer generally to temperature moderating assemblies that are configured to cool, or reduce the temperature of, all or selected regions of the fuel processing system.

In FIG. 2, an illustrative example of a hydrogen-generation assembly 46 is shown that includes fuel processing system 64 with a hydrogen-producing region 70 that is adapted to produce mixed gas stream 74 by steam reforming one or more feedstock supply streams 68 containing water 80 and at least one carbon-containing feedstock 82. As illustrated, region 70 includes at least one reforming catalyst bed 84 containing one or more suitable reforming catalysts 86. In the illustrative example, the hydrogen-producing region may be referred to as a reforming region, and the mixed gas stream may be referred to as a reformate stream.

As also shown in FIGS. 1 and 2, the mixed gas stream is adapted to be delivered to a separation region, or assembly, 72 that includes at least one PSA assembly 73. PSA assembly 73 is adapted to separate the mixed gas (or reformate) stream into product hydrogen stream 42 and at least one byproduct stream 76 that contains at least a substantial portion of the impurities, or other gases, present in mixed gas stream 74. Product hydrogen stream 42 includes a greater concentration of hydrogen gas, and/or a lower concentration of at least selected impurities, than the mixed gas stream and may contain pure, or at least substantially pure, hydrogen gas. Byproduct stream 76 may contain no hydrogen gas, but it typically will contain some hydrogen gas. While not required, it is within the scope of the present disclosure that fuel processing system 64 may be adapted to produce one or more byproduct streams containing sufficient amounts of hydrogen (and/or other) gas(es) to be suitable for use as a fuel, or feedstock, stream for a heating assembly for the fuel processing system. In some embodiments, the byproduct stream may have sufficient fuel value (i.e., hydrogen and/or other combustible gas content) to enable the heating assembly, when present, to maintain the hydrogen-producing region at a desired operating temperature or within a selected range of temperatures.

As illustrated in FIG. 2, the hydrogen-generation assembly includes a temperature modulating assembly in the form of a heating assembly 71 that is adapted to produce a heated exhaust stream 88 that is adapted to heat at least the reforming region of the hydrogen-generation assembly. It is within the scope of the present disclosure that stream 88 may be used to heat other portions of the hydrogen-generation assembly and/or energy-producing system 22.

As indicated in dashed lines in FIGS. 1 and 2, it is within the scope of the present disclosure that the byproduct stream from the PSA assembly may form at least a portion of the fuel stream for the heating assembly. Also shown in FIG. 2 are air stream 90, which may be delivered from any suitable air source, and fuel stream 92, which contains any suitable combustible fuel suitable for being combusted with air in the heating assembly. Fuel stream 92 may be used as the sole fuel stream for the heating assembly, but as discussed, it is also within the scope of the disclosure that other combustible fuel streams may be used, such as the byproduct stream from the PSA assembly, the anode exhaust stream from a fuel cell stack, etc. When the byproduct or exhaust streams from other components of system 22 have sufficient fuel value, fuel stream 92 may not be used. When they do not have sufficient fuel value, are used for other purposes, or are not being generated, fuel stream 92 may be used instead or in combination.

Illustrative examples of suitable fuels include one or more of the above-described carbon-containing feedstocks, although others may be used. As an illustrative example of temperatures that may be achieved and/or maintained in hydrogen-producing region 70 through the use of heating assembly 71, steam reformers typically operate at temperatures in the range of 200° C. and 900° C. Temperatures outside of this range are within the scope of the disclosure. When the carbon-containing feedstock is methanol, the steam reforming reaction will typically operate in a temperature range of approximately 200-500° C. Illustrative subsets of this range include 350-450° C., 375-425° C., and 375-400° C. When the carbon-containing feedstock is a hydrocarbon, ethanol, or a similar alcohol, a temperature range of approximately 400-900° C. will typically be used for the steam reforming reaction. Illustrative subsets of this range include 750-850° C., 725-825° C., 650-750° C., 700-800° C., 700-900° C., 500-800° C., 400-600° C., and 600-800° C.

It is within the scope of the present disclosure that the separation region may be implemented within system 22 anywhere downstream from the hydrogen-producing region and upstream from the fuel cell stack. In the illustrative example shown schematically in FIG. 1, the separation region is depicted as part of the hydrogen-generation assembly, but this construction is not required. It is also within the scope of the present disclosure that the hydrogen-generation assembly may utilize a chemical or physical separation process in addition to PSA assembly 73 to remove or reduce the concentration of one or more selected impurities from the mixed gas stream. When separation assembly 72 utilizes a separation process in addition to PSA, the one or more additional processes may be performed at any suitable location within system 22 and are not required to be implemented with the PSA assembly. An illustrative chemical separation process is the use of a methanation catalyst to selectively reduce the concentration of carbon monoxide present in stream 74. Other illustrative chemical separation processes include partial oxidation of carbon monoxide to form carbon dioxide and water-gas shift reactions to produce hydrogen gas and carbon dioxide from water and carbon monoxide. Illustrative physical separation processes include the use of a physical membrane or other barrier adapted to permit the hydrogen gas to flow therethrough but adapted to prevent at least selected impurities from passing therethrough. These membranes may be referred to as being hydrogen-selective membranes. Illustrative examples of suitable membranes are formed from palladium or a palladium alloy and are disclosed in the references incorporated herein.

The hydrogen-generation assembly 46 preferably is adapted to produce at least substantially pure hydrogen gas, and even more preferably (although not required), the hydrogen-generation assembly is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% or even 99.9% pure. Illustrative, nonexclusive examples of suitable fuel processing systems are disclosed in U.S. Pat. Nos. 6,221,117, 5,997,594, 5,861,137, and pending U.S. Patent Application Publication Nos. 2001/0045061, 2003/0192251, and 2003/0223926. The complete disclosures of the above-identified patents and patent applications are hereby incorporated by reference for all purposes.

Hydrogen gas from the fuel processing system 64 may be delivered to one or more of the storage device 62 and the fuel cell stack 24 via product hydrogen stream 42. Some or all of hydrogen stream 42 may additionally, or alternatively, be delivered, via a suitable conduit, for use in another hydrogen-consuming process, burned for fuel or heat, or stored for later use. With reference to FIG. 1, the hydrogen gas may be used as a proton source, or reactant, for fuel cell stack 24 and may be delivered to the stack from one or more of fuel processing system 64 and storage device 62. Fuel cell stack 24 includes at least one fuel cell 20, and typically includes a plurality of fluidly and electrically interconnected fuel cells. When these cells are connected together in series, the power output of the fuel cell stack is the sum of the power outputs of the individual cells. The cells in stack 24 may be connected in series, parallel, or combinations of series and parallel configurations.

FIG. 3 illustrates schematically a fuel cell 20, one or more of which may be configured to form fuel cell stack 24. The fuel cell stacks of the present disclosure may utilize any suitable type of fuel cell, and preferably fuel cells that receive hydrogen and oxygen as proton sources and oxidants. Illustrative examples of types of fuel cells include proton exchange membrane (PEM) fuel cells, alkaline fuel cells, solid oxide fuel cells, molten carbonate fuel cells, phosphoric acid fuel cells, and the like. For the purpose of illustration, an exemplary fuel cell 20 in the form of a PEM fuel cell is schematically illustrated in FIG. 3.

Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a support 39, such as a supporting plate 40. Support 39 may form a portion of the bipolar plate assemblies that are discussed in more detail herein. The supporting plates 40 of fuel cells 20 carry the relative voltage potentials produced by the fuel cells.

In operation, hydrogen gas from product hydrogen stream 42 is delivered to the anode region, and oxidant 44 is delivered to the cathode region. A typical, but not exclusive, oxidant is oxygen. As used herein, hydrogen refers to hydrogen gas and oxygen refers to oxygen gas. The following discussion will refer to hydrogen as the proton source, or fuel, for the fuel cell (stack), and oxygen as the oxidant, although it is within the scope of the present disclosure that other fuels and/or oxidants may be used. Hydrogen and oxygen 44 may be delivered to the respective regions of the fuel cell via any suitable mechanism from respective sources 47 and 48. Illustrative examples of suitable sources 47 of hydrogen include a hydrogen storage device, fuel processing system, or other pressurized source of hydrogen gas. Illustrative examples of suitable sources 48 of oxygen 44 include a pressurized tank of oxygen or air, or a fan, compressor, blower or other device for directing air to the cathode region.

Hydrogen and oxygen typically combine with one another via an oxidation-reduction reaction. Although membrane 28 restricts the passage of a hydrogen molecule, it will permit a hydrogen ion (proton) to pass through it, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 3. In cathode region 32, electrons from the external circuit and protons from the membrane combine with oxygen to produce water and heat.

Also shown in FIG. 3 are an anode purge, or exhaust, stream 54, which may contain hydrogen gas, and a cathode air exhaust stream 55, which is typically at least partially, if not substantially, depleted of oxygen. Fuel cell stack 24 may include a common hydrogen (or other reactant) feed, air intake, and stack purge and exhaust streams, and accordingly will include suitable fluid conduits to deliver the associated streams to, and collect the streams from, the individual fuel cells. Similarly, any suitable mechanism may be used for selectively purging the regions.

In practice, a fuel cell stack 24 will typically contain a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load, such as from at least one of an energy-consuming device 52 and the energy-producing system 22.

For a constant output voltage, such as 12 volts or 24 volts, the output power may be determined by measuring the output current. The electrical output may be used to satisfy an applied load, such as from energy-consuming device 52. FIG. 1 schematically depicts that energy-producing system 22 may include at least one energy-storage device 78. Device 78, when included, may be adapted to store at least a portion of the electrical output, or power, 79 from the fuel cell stack 24. An illustrative example of a suitable energy-storage device 78 is a battery, but others may be used. Energy-storage device 78 may additionally, or alternatively, be used to power the energy-producing system 22 during start-up of the system.

The at least one energy-consuming device 52 may be electrically coupled to the energy-producing system 22, such as to the fuel cell stack 24 and/or one or more energy-storage devices 78 associated with the stack. Device 52 applies a load to the energy-producing system 22 and draws an electric current from the system to satisfy the load. This load may be referred to as an applied load, and may include thermal and/or electrical load(s). It is within the scope of the present disclosure that the applied load may be satisfied by the fuel cell stack, the energy-storage device, or both the fuel cell stack and the energy-storage device. Illustrative examples of devices 52 include motor vehicles, recreational vehicles, boats and other sea craft, and any combination of one or more residences, commercial offices or buildings, neighborhoods, tools, lights and lighting assemblies, appliances, computers, industrial equipment, signaling and communications equipment, radios, electrically powered components on boats, recreational vehicles or other vehicles, battery chargers and even the balance-of-plant electrical requirements for the energy-producing system 22 of which fuel cell stack 24 forms a part. As indicated in dashed lines at 77 in FIG. 1, the energy-producing system may, but is not required to, include at least one power management module 77. Power management module 77 includes any suitable structure for conditioning or otherwise regulating the electricity produced by the energy-producing system, such as for delivery to energy-consuming device 52. Module 77 may include such illustrative structure as buck or boost converters, inverters, power filters, and the like.

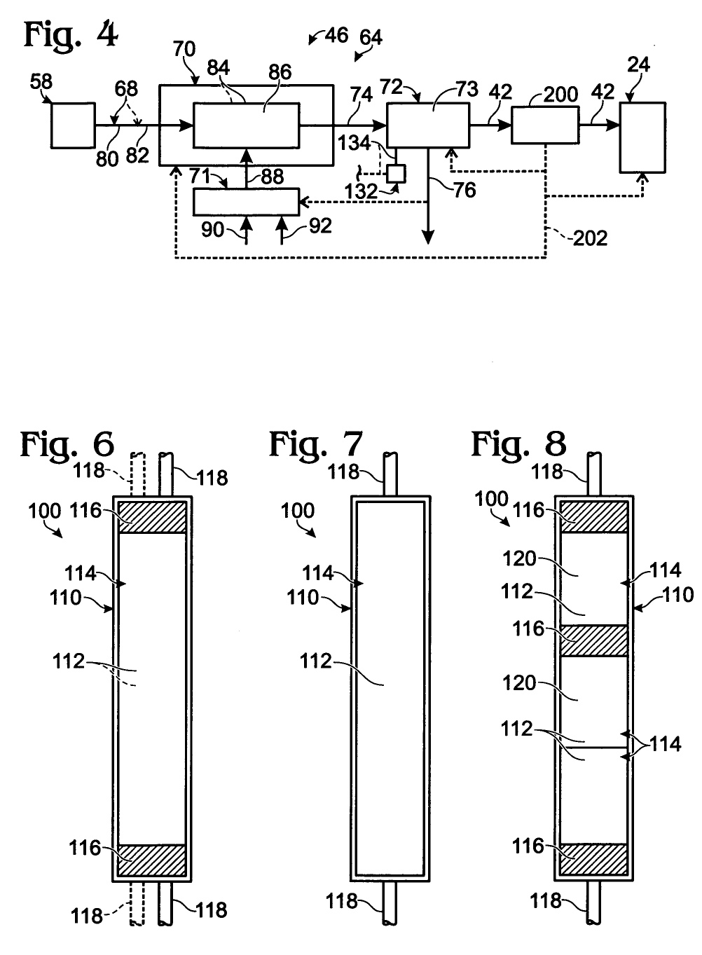

In FIG. 4, an illustrative example of an energy-producing system 22 with an energy recovery assembly 200 is shown. The energy recovery assembly may include any suitable device(s) and/or structure(s) configured to recover any suitable type(s) of energy from an energy-containing stream of system 22. For example, energy recovery assembly 200 may be configured to recover mechanical energy from product hydrogen stream 42 of PSA assembly 73. For example, the energy recovery assembly may be adapted to generate mechanical energy by utilizing the product hydrogen stream to drive a gas motor or other energy recovery device, which in turn may be adapted to power, or drive, the operation of one or more other devices, such as a vacuum pump. This energy recovery process will reduce the pressure in the product hydrogen stream but will not consume the product hydrogen stream or otherwise prevent the use of the product hydrogen stream as a fuel for the fuel cell stack. In this example, the pressure of the stream is merely reduced from its pressure prior to being received by the energy-recovery assembly. Otherwise, the composition of the stream may remain unchanged. The vacuum generated by the vacuum pump may thereafter be utilized, or applied, as discussed herein. Illustrative examples of energy recovery assemblies are discussed below.

Additionally, the energy recovery assembly may be configured to apply recovered energy 202 to one or more components of energy-producing system 22. For example, recovered energy 202 may be applied to one or more components of hydrogen-producing region 70, temperature modulating assembly 71, separation region 72 (including the subsequently described pressure swing adsorption assemblies), and/or fuel cell stack 24. As a further non-exclusive example, this recovered energy may be applied by using it to drive, or to assist in the driving, of pumps, compressors, blowers, and the like, which in turn may be adapted to assist in the operation of a component of system 22, such as one of the components discussed herein. It is within the scope of the disclosure that at least a portion of recovered energy 202 may be applied to component(s), device(s), and/or system(s) outside of energy-producing system 22. It is within the scope of the disclosure that energy recovery assembly 200 may alternatively, or additionally, recover other suitable type(s) of energy from an energy producing system, such as heat or thermal energy. It also is within the scope of the disclosure that the energy recovery assembly alternatively, or additionally, is adapted to recover energy from other suitable stream(s) and/or component(s) of the energy producing system. Illustrative examples of suitable streams include reflux streams, blowdown streams, purge streams, feed streams, etc.

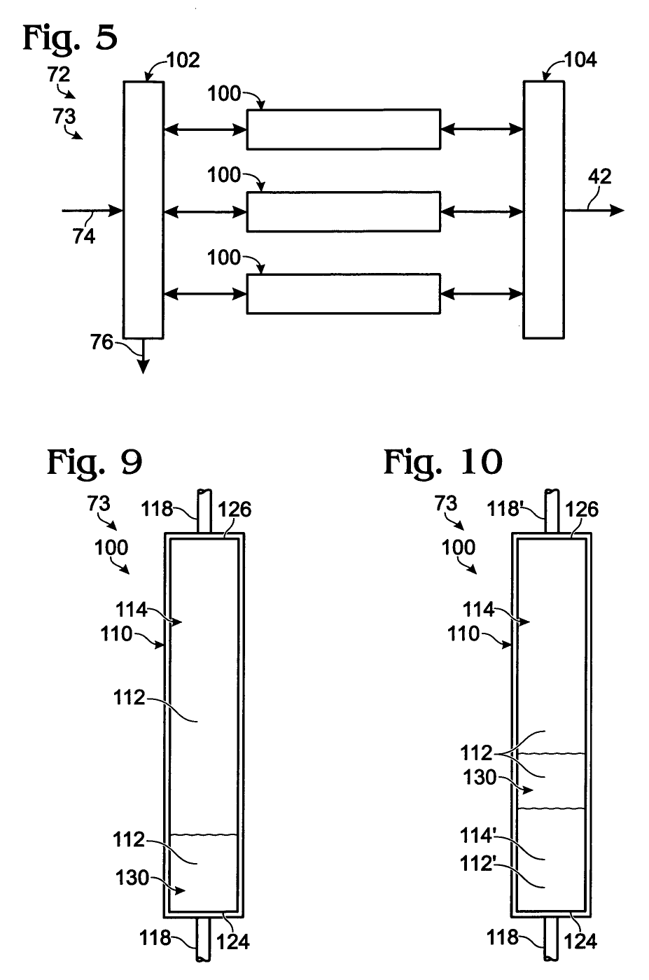

In FIG. 5 an illustrative example of a PSA assembly 73 is shown. As shown, assembly 73 includes a plurality of adsorbent beds 100 that are fluidly connected via distribution assemblies 102 and 104. Beds 100 may additionally, or alternatively, be referred to as adsorbent chambers or adsorption regions. The distribution assemblies have been schematically illustrated in FIG. 5 and may include any suitable structure for selectively establishing and restricting fluid flow between the beds and/or the input and output streams of assembly 73. As shown, the input and output streams include at least mixed gas stream 74, product hydrogen stream 42, and byproduct stream 76. Illustrative examples of suitable structures include one or more of manifolds, such as distribution and collection manifolds that are respectively adapted to distribute fluid to and collect fluid from the beds, and valves, such as check valves, solenoid valves, purge valves, and the like. In the illustrative example, three beds 100 are shown, but it is within the scope of the present disclosure that the number of beds may vary, such as to include more or less beds than shown in FIG. 5. Typically, assembly 73 will include at least two beds, and often will include three, four, or more beds. While not required, assembly 73 is preferably adapted to provide a continuous flow of product hydrogen stream 42, with at least one of the plurality of beds exhausting this stream when the assembly is in use and receiving a continuous flow of mixed gas stream 74.

In the illustrative example, distribution assembly 102 is adapted to selectively deliver mixed gas stream 74 to the plurality of beds and to collect and exhaust byproduct stream 76, and distribution assembly 104 is adapted to collect the purified hydrogen gas that passes through the beds and which forms product hydrogen stream 42. The distribution assemblies may be configured for fixed or rotary positioning relative to the beds. Furthermore, the distribution assemblies may include any suitable type and number of structures and devices to selectively distribute, regulate, meter, prevent and/or collect flows of the corresponding gas streams. As illustrative, non-exclusive examples, distribution assembly 102 may include mixed gas and exhaust manifolds, or manifold assemblies, and distribution assembly 104 may include product and purge manifolds, or manifold assemblies. In practice, PSA assemblies that utilize distribution assemblies that rotate relative to the beds may be referred to as rotary pressure swing adsorption assemblies, and PSA assemblies in which the manifolds and beds are not adapted to rotate relative to each other to selectively establish and restrict fluid connections may be referred to as fixed bed, or discrete bed, pressure swing adsorption assemblies. Both constructions are within the scope of the present disclosure.

Gas purification by pressure swing adsorption involves sequential pressure cycling and flow reversal of gas streams relative to the adsorbent beds. In the context of purifying a mixed gas stream comprised of hydrogen gas as the majority component, the mixed gas stream is delivered under relatively high pressure to one end of the adsorbent beds and thereby exposed to the adsorbent(s) contained in the adsorbent region thereof. Illustrative examples of delivery pressures for mixed gas stream 74 include pressures in the range of 40-200 psi, such as pressures in the range of 50-150 psi, 50-100 psi, 100-150 psi, 70-100 psi, etc., although pressures outside of this range are within the scope of the present disclosure. As the mixed gas stream flows through the adsorbent region, carbon monoxide, carbon dioxide, water and/or other ones of the impurities, or other gases, are adsorbed, and thereby at least temporarily retained, on the adsorbent. This is because these gases are more readily adsorbed on the selected adsorbents used in the PSA assembly. The remaining portion of the mixed gas stream, which now may perhaps more accurately be referred to as a purified hydrogen stream, passes through the bed and is exhausted from the other end of the bed. In this context, hydrogen gas may be described as being the less readily adsorbed component, while carbon monoxide, carbon dioxide, etc., may be described as the more readily adsorbed components of the mixed gas stream. The pressure of the product hydrogen stream is typically reduced prior to utilization of the gas by the fuel cell stack.

To remove the adsorbed gases, the flow of the mixed gas stream is stopped, the pressure in the bed is reduced, and the now desorbed gases are exhausted from the bed. The desorption step often includes selectively decreasing the pressure within the adsorbent region through the withdrawal of gas, typically in a countercurrent direction relative to the feed direction. This desorption step may also be referred to as a depressurization, or blowdown, step. This step often includes or is performed in conjunction with the use of a purge gas stream, which is typically delivered in a countercurrent flow direction to the direction at which the mixed gas stream flows through the adsorbent region. An illustrative example of a suitable purge gas stream is a portion of the product hydrogen stream, as this stream is comprised of hydrogen gas, which is less readily adsorbed than the adsorbed gases. Other gases may be used in the purge gas stream, although these gases preferably are less readily adsorbed than the adsorbed gases, and even more preferably are not adsorbed, or are only weakly adsorbed, on the adsorbent(s) being used.

As discussed herein, the desorption and/or purge steps may include drawing an at least partial vacuum on the bed, but this is not required. Drawing the at least partial vacuum on the bed may occur during the entire desorption and/or purge steps. Alternatively, drawing the at least partial vacuum on the bed may occur during one or more portions of the desorption and/or purge steps, such as one or more of the beginning of the desorption step, the middle of the desorption step, the end of the desorption step, the beginning of the purge step, the middle of the purge step, the end of the purge step, and/or any suitable combination of those portions. In some embodiments, the at least partial vacuum may be applied during at least the middle and/or end of the purge step to remove the impurities that would not otherwise be removed without the at least partial vacuum.

While not required, it is often desirable to utilize one or more equalization steps, in which two or more beds are fluidly interconnected to permit the beds to equalize the relative pressures therebetween. For example, one or more equalization steps may precede the desorption and pressurization steps. Prior to the desorption step, equalization is used to reduce the pressure in the bed and to recover some of the purified hydrogen gas contained in the bed, while prior to the (re)pressurization step, equalization is used to increase the pressure within the bed. Equalization may be accomplished using cocurrent and/or countercurrent flow of gas. After the desorption and/or purge step(s) of the desorbed gases is completed, the bed is again pressurized and ready to again receive and remove impurities from the portion of the mixed gas stream delivered thereto.

For example, when a bed is ready to be regenerated, it is typically at a relatively high pressure and contains a quantity of hydrogen gas. While this gas (and pressure) may be removed simply by venting the bed, other beds in the assembly will need to be pressurized prior to being used to purify the portion of the mixed gas stream delivered thereto. Furthermore, the hydrogen gas in the bed to be regenerated preferably is recovered so as to not negatively impact the efficiency of the PSA assembly. Therefore, interconnecting these beds in fluid communication with each other permits the pressure and hydrogen gas in the bed to be regenerated to be reduced while also increasing the pressure and hydrogen gas in a bed that will be used to purify impure hydrogen gas (i.e., mixed gas stream 74) that is delivered thereto. In addition to, or in place of, one or more equalization steps, a bed that will be used to purify the mixed gas stream may be pressurized prior to the delivery of the mixed gas stream to the bed. For example, some of the purified hydrogen gas may be delivered to the bed to pressurize the bed. While it is within the scope of the present disclosure to deliver this pressurization gas to either end of the bed, in some embodiments it may be desirable to deliver the pressurization gas to the opposite end of the bed than the end to which the mixed gas stream is delivered.

The above discussion of the general operation of a PSA assembly has been somewhat simplified. Illustrative examples of pressure swing adsorption assemblies, including components thereof and methods of operating the same, are disclosed in U.S. Pat. Nos. 3,564,816, 3,986,849, 5,441,559, 6,692,545, and 6,497,856, and U.S. patent application Ser. Nos. 11/055,843 and 11/058,307; the complete disclosures of these patents and patent applications are hereby incorporated by reference for all purposes.

In FIG. 6, an illustrative example of an adsorbent bed 100 is schematically illustrated. As shown, the bed defines an internal compartment 110 that contains at least one adsorbent 112, with each adsorbent being adapted to adsorb one or more of the components of the mixed gas stream. It is within the scope of the present disclosure that more than one adsorbent may be used. For example, a bed may include more than one adsorbent adapted to adsorb a particular component of the mixed gas stream, such as to adsorb carbon monoxide, and/or two or more adsorbents that are each adapted to adsorb a different component of the mixed gas stream. Similarly, an adsorbent may be adapted to adsorb two or more components of the mixed gas stream. Illustrative (non-exclusive) examples of suitable adsorbents include activated carbon, alumina and zeolite adsorbents. An additional example of an adsorbent that may be present within the adsorbent region of the beds is a desiccant that is adapted to adsorb water present in the mixed gas stream. Illustrative desiccants include silica and alumina gels. When two or more adsorbents are utilized, they may be sequentially positioned (in a continuous or discontinuous relationship) within the bed or may be mixed together. It should be understood that the type, number, amount, and form of adsorbent in a particular PSA assembly may vary, such as according to one or more of the following factors: the operating conditions expected in the PSA assembly, the size of the adsorbent bed, the composition and/or properties of the mixed gas stream, the desired application for the product hydrogen stream produced by the PSA assembly, the operating environment in which the PSA assembly will be used, user preferences, etc.

When the PSA assembly includes a desiccant or other water-removal composition or device, it may be positioned to remove water from the mixed gas stream prior to adsorption of other impurities from the mixed gas stream. One reason for this is that water may negatively affect the ability of some adsorbents to adsorb other components of the mixed gas stream, such as carbon monoxide. An illustrative example of a water-removal device is a condenser, but others may be used between the hydrogen-producing region and adsorbent region, as schematically illustrated in dashed lines at 122 in FIG. 1. For example, at least one heat exchanger, condenser or other suitable water-removal device may be used to cool the mixed gas stream prior to delivery of the stream to the PSA assembly. This cooling may condense some of the water present in the mixed gas stream. Continuing this example, and to provide a more specific illustration, mixed gas streams produced by steam reformers tend to contain at least 10%, and often at least 15% or more water when exhausted from the hydrogen-producing (i.e., the reforming) region of the fuel processing system. These streams also tend to be fairly hot, such as having a temperature of at least 300° C. (in the case of many mixed gas streams produced from methanol or similar carbon-containing feedstocks), and at least 600-800° C. (in the case of many mixed gas streams produced from natural gas, propane or similar carbon-containing feedstocks). When cooled prior to delivery to the PSA assembly, such as to an illustrative temperature in the range of 25-100° C. or even 40-80° C., most of this water will condense. The mixed gas stream may still be saturated with water, but the water content will tend to be less than 5 wt %.

The adsorbent(s) may be present in the bed in any suitable form, illustrative examples of which include particulate form, bead form, porous discs or blocks, coated structures, laminated sheets, fabrics, and the like. When positioned for use in the beds, the adsorbents should provide sufficient porosity and/or gas flow paths for the non-adsorbed portion of the mixed gas stream to flow through the bed without significant pressure drop through the bed. As used herein, the portion of a bed that contains adsorbent will be referred to as the adsorbent region of the bed. In FIG. 6, an adsorbent region is indicated generally at 114. Beds 100 also may (but are not required to) include partitions, supports, screens and other suitable structure for retaining the adsorbent and other components of the bed within the compartment, in selected positions relative to each other, in a desired degree of compression, etc. These devices are generally referred to as supports and are generally indicated in FIG. 6 at 116. Therefore, it is within the scope of the present disclosure that the adsorbent region may correspond to the entire internal compartment of the bed, or only a subset thereof. Similarly, the adsorbent region may be comprised of a continuous region or two or more spaced-apart regions without departing from the scope of the present disclosure.

In the illustrated example shown in FIG. 6, bed 100 includes at least one port 118 associated with each end region of the bed. As indicated in dashed lines, it is within the scope of the present disclosure that either or both ends of the bed may include more than one port. Similarly, it is within the scope of the disclosure that the ports may extend laterally from the beds or otherwise have a different geometry than the schematic examples shown in FIG. 6. Regardless of the configuration and/or number of ports, the ports are collectively adapted to deliver fluid for passage through the adsorbent region of the bed and to collect fluid that passes through the adsorbent region. As discussed, the ports may selectively, such as depending upon the particular implementation of the PSA assembly and/or stage in the PSA cycle, be used as an input port or an output port. For the purpose of providing a graphical example, FIG. 7 illustrates a bed 100 in which the adsorbent region extends along the entire length of the bed, i.e., between the opposed ports or other end regions of the bed. In FIG. 8, bed 100 includes an adsorbent region 1 14 that includes discontinuous subregions 120.

During use of an adsorbent bed, such as bed 100, to adsorb impurity gases (namely the gases with greater affinity for being adsorbed by the adsorbent), a mass-transfer zone will be defined in the adsorbent region. More particularly, adsorbents have a certain adsorption capacity, which is defined, at least in part, by the composition of the mixed gas stream, the flow rate of the mixed gas stream, the operating temperature and/or pressure at which the adsorbent is exposed to the mixed gas stream, any adsorbed gases that have not been previously desorbed from the adsorbent, etc. As the mixed gas stream is delivered to the adsorbent region of a bed, the adsorbent at the end portion of the adsorbent region proximate the mixed gas delivery port will remove impurities from the mixed gas stream. Generally, these impurities will be adsorbed within a subset of the adsorbent region, and the remaining portion of the adsorbent region will have only minimal, if any, adsorbed impurity gases. This is somewhat schematically illustrated in FIG. 9, in which adsorbent region 114 is shown including a mass transfer zone, or region, 130.

As the adsorbent in the initial mass transfer zone continues to adsorb impurities, it will near or even reach its capacity for adsorbing these impurities. As this occurs, the mass transfer zone will move toward the opposite end of the adsorbent region. More particularly, as the flow of impurity gases exceeds the capacity of a particular portion of the adsorbent region (i.e., a particular mass transfer zone) to adsorb these gases, the gases will flow beyond that region and into the adjoining portion of the adsorbent region, where they will be adsorbed by the adsorbent in that portion, effectively expanding and/or moving the mass transfer zone generally toward the opposite end of the bed.

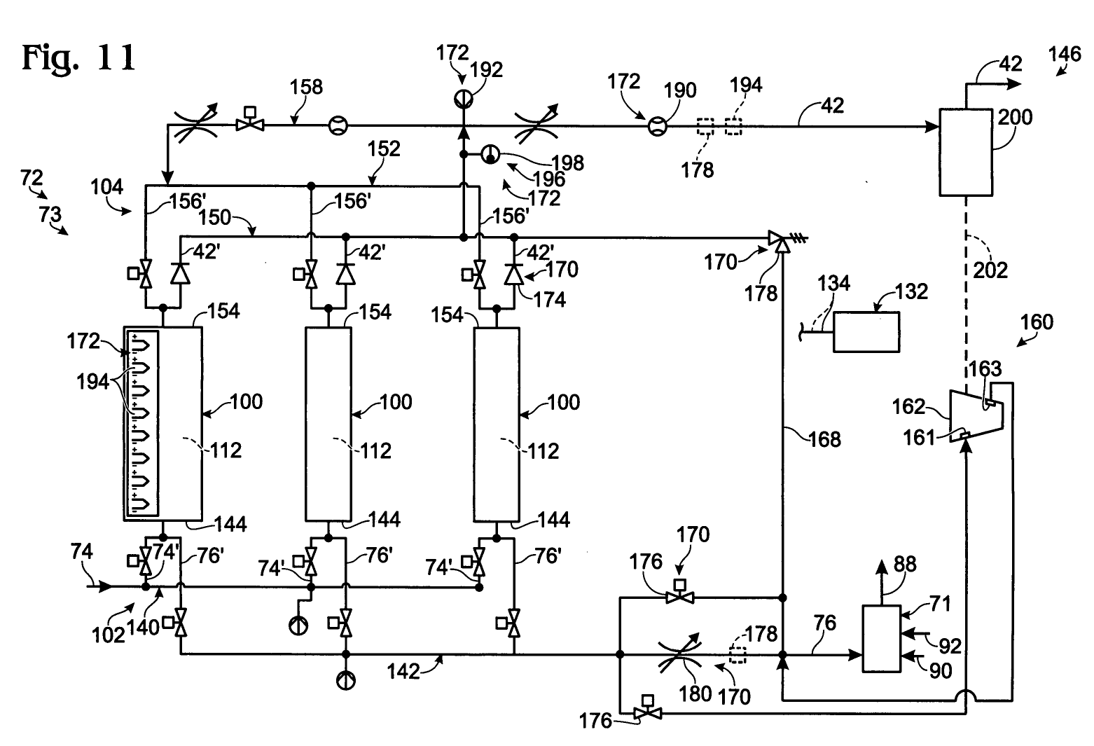

This description is somewhat simplified in that the mass transfer zone often does not define uniform beginning and ending boundaries along the adsorbent region, especially when the mixed gas stream contains more than one gas that is adsorbed by the adsorbent. Similarly, these gases may have different affinities for being adsorbed and therefore may even compete with each other for adsorbent sites. However, a substantial portion (such as at least 70% or more) of the adsorption will tend to occur in a relatively localized portion of the adsorbent region, with this portion, or zone, tending to migrate from the feed end to the product end of the adsorbent region during use of the bed. This is schematically illustrated in FIG. 10, in which mass transfer zone 130 is shown moved toward port 118′ relative to its position in FIG. 9. Accordingly, the adsorbent 112′ in portion 114′ of the adsorbent region will have a substantially reduced capacity, if any, to adsorb additional impurities. Described in other terms, adsorbent 112′ may be described as being substantially, if not completely, saturated with adsorbed gases. In FIGS. 9 and 10, the feed and product ends of the adsorbent region are generally indicated at 124 and 126 and generally refer to the portions of the adsorbent region that are proximate, or closest to, the mixed gas delivery port and the product port of the bed.

During use of the PSA assembly, the mass transfer zone will tend to migrate toward and away from ends 124 and 126 of the adsorbent region. More specifically, and as discussed, PSA is a cyclic process that involves repeated changes in pressure and flow direction. The following discussion will describe the PSA cycle with reference to how steps in the cycle tend to affect the mass transfer zone (and/or the distribution of adsorbed gases through the adsorbent region). It should be understood that the size, or length, of the mass transfer zone will tend to vary during use of the PSA assembly, and therefore tends not to be of a fixed dimension.

At the beginning of a PSA cycle, the bed is pressurized and the mixed gas stream flows under pressure through the adsorbent region. During this adsorption step, impurities (i.e., the other gases) are adsorbed by the adsorbent(s) in the adsorbent region. As these impurities are adsorbed, the mass transfer zone tends to move toward the distal, or product, end of the adsorbent region as initial portions of the adsorbent region become more and more saturated with adsorbed gas. When the adsorption step is completed, the flow of mixed gas stream 74 to the adsorbent bed and the flow of purified hydrogen gas (at least a portion of which will form product hydrogen stream 42) are stopped. While not required, the bed may then undergo one or more equalization steps in which the bed is fluidly interconnected with one or more other beds in the PSA assembly to decrease the pressure and hydrogen gas present in the bed and to charge the receiving bed(s) with pressure and hydrogen gas. Gas may be withdrawn from the pressurized bed from either, or both of, the feed or the product ports. Drawing the gas from the product port will tend to provide hydrogen gas of greater purity than gas drawn from the feed port. However, the decrease in pressure resulting from this step will tend to draw impurities in the direction at which the gas is removed from the adsorbent bed. Accordingly, the mass transfer zone may be described as being moved toward the end of the adsorbent bed closest to the port from which the gas is removed from the bed. Expressed in different terms, when the bed is again used to adsorb impurities from the mixed gas stream, the portion of the adsorbent region in which the majority of the impurities are adsorbed at a given time, i.e., the mass transfer zone, will tend to be moved toward the feed or product end of the adsorbent region depending upon the direction at which the equalization gas is withdrawn from the bed.

The bed is then depressurized, with this step typically drawing gas from the feed port because the gas stream will tend to have a higher concentration of the other gases, which are desorbed from the adsorbent as the pressure in the bed is decreased. This exhaust stream may be referred to as a byproduct, or impurity stream, 76 and may be used for a variety of applications, including as a fuel stream for a burner or other heating assembly that combusts a fuel stream to produce a heated exhaust stream. As discussed, hydrogen-generation assembly 46 may include a heating assembly 71 that is adapted to produce a heated exhaust stream to heat at least the hydrogen-producing region 70 of the fuel processing system. According to Henry's Law, the amount of adsorbed gases that are desorbed from the adsorbent is related to the partial pressure of the adsorbed gas present in the adsorbent bed. Therefore, the depressurization step may include, be followed by, or at least partially overlap in time, with a purge step, in which gas, typically at low pressure, is introduced into the adsorbent bed. This gas flows through the adsorbent region and draws the desorbed gases away from the adsorbent region, with this removal of the desorbed gases resulting in further desorption of gas from the adsorbent. As discussed, a suitable purge gas is purified hydrogen gas, such as previously produced by the PSA assembly. Typically, the purge stream flows from the product end to the feed end of the adsorbent region to urge the impurities (and thus reposition the mass transfer zone) toward the feed end of the adsorbent region. It is within the scope of the disclosure that the purge gas stream may form a portion of the byproduct stream, may be used as a combustible fuel stream (such as for heating assembly 71), and/or may be otherwise utilized in the PSA or other processes.

The illustrative example of a PSA cycle is now completed, and a new cycle is typically begun. For example, the purged adsorbent bed is then repressurized, such as by being a receiving bed for another adsorbent bed undergoing equalization, and optionally may be further pressurized by purified hydrogen gas delivered thereto. By utilizing a plurality of adsorbent beds, typically three or more, the PSA assembly may be adapted to receive a continuous flow of mixed gas stream 74 and to produce a continuous flow of purified hydrogen gas (i.e., a continuous flow of product hydrogen stream 42). While not required, the time for the adsorption step, or stage, often represents one-third to two-thirds of the PSA cycle, such as representing approximately half of the time for a PSA cycle.

The adsorption step preferably should be stopped before the mass transfer zone reaches the distal end (relative to the direction at which the mixed gas stream is delivered to the adsorbent region) of the adsorbent region. In other words, the flow of mixed gas stream 74 and the removal of product hydrogen stream 42 preferably should be stopped before the other gases that are desired to be removed from the hydrogen gas are exhausted from the bed with the hydrogen gas because the adsorbent is saturated with adsorbed gases and therefore can no longer effectively prevent these impurity gases from being exhausted in what desirably is a purified hydrogen stream. This contamination of the product hydrogen stream with impurity gases that desirably are removed by the PSA assembly may be referred to as breakthrough, in that the impurities gases “break through” the adsorbent region of the bed. Conventionally, carbon monoxide detectors have been used to determine when the mass transfer zone is nearing or has reached the distal end of the adsorbent region and thereby is, or will, be present in the product hydrogen stream. Carbon monoxide detectors are used more commonly than detectors for other ones of the other gases present in the mixed gas stream because carbon monoxide can damage many fuel cells, such as proton exchange membrane (PEM) fuel cells, when present in even a few parts per million (ppm). While effective, and within the scope of the present disclosure, this detection mechanism requires the use of carbon monoxide detectors and related detection equipment, which tends to be expensive and increase the complexity of the PSA assembly.

As introduced in connection with FIG. 5, PSA assembly 73 includes distribution assemblies 102 and 104 that selectively deliver and/or collect mixed gas stream 74, product hydrogen stream 42, and byproduct stream 76 to and from the plurality of adsorbent beds 100. As discussed, product hydrogen stream 42 is formed from the purified hydrogen gas streams produced in the adsorbent regions of the adsorbent beds. It is within the scope of the present disclosure that some of this gas may be used as a purge gas stream that is selectively delivered (such as via an appropriate distribution manifold) to the adsorbent beds during the purge and/or blowdown steps to promote the desorption and removal of the adsorbed gases for the adsorbent. The desorbed gases, as well as the purge gas streams that are withdrawn from the adsorbent beds with the desorbed gases collectively may form byproduct stream 76, which as discussed, may be used as a fuel stream for heating assembly 71 or other device that is adapted to receive a combustible fuel stream.

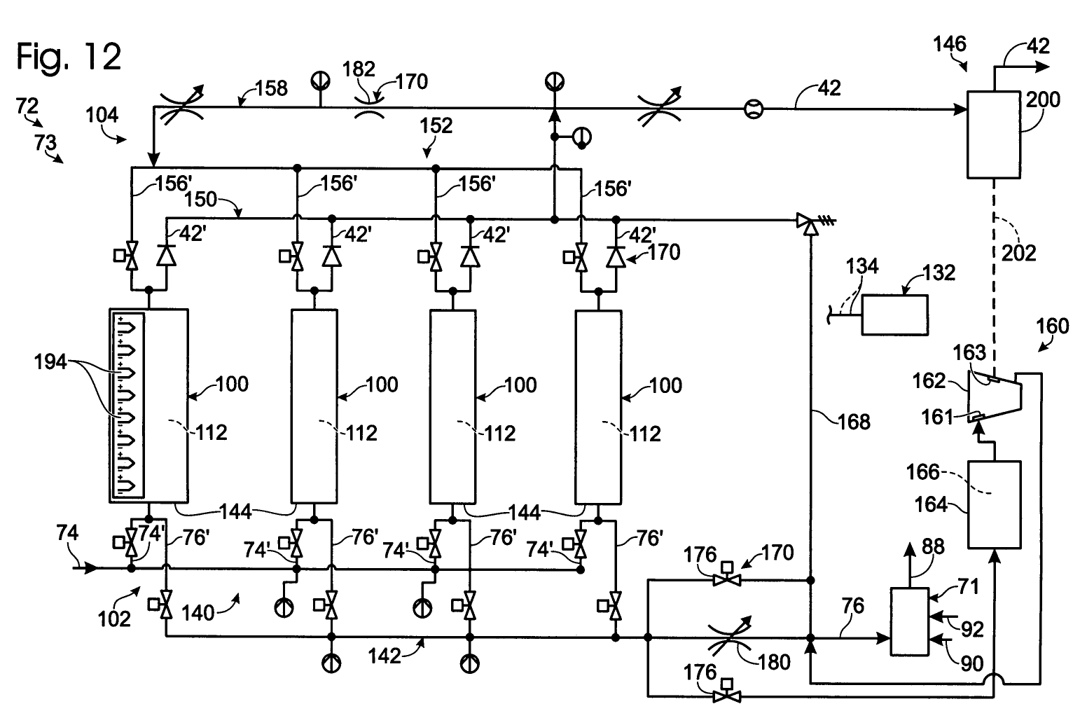

FIGS. 11 and 12 provide somewhat less schematic examples of PSA assemblies 73 that include a plurality of adsorbent beds 100. Similar to the illustrative example shown in FIG. 5, three adsorbent beds are shown in FIG. 11. As discussed, it is within the scope of the present disclosure that more or less beds may be utilized. This is graphically depicted in FIG. 12, in which four beds are shown, although more than four beds may be utilized without departing from the scope of the present disclosure. Similarly, more than one PSA assembly may be used in connection with the same hydrogen-generation assembly and/or fuel cell system. As shown in FIGS. 11 and 12, PSA assembly 73 includes a distribution assembly 102 that includes a mixed gas manifold 140 and an exhaust manifold 142. Mixed gas manifold 140 is adapted to selectively distribute the mixed gas stream to the feed ends 144 of the adsorbent beds, as indicated at 74′. Exhaust manifold 142 is adapted to collect gas that is exhausted from the feed ends of the adsorbent beds, namely, the desorbed other gases, purge gas, and other gas that is not harvested to form product hydrogen stream 42. These exhausted streams are indicated at 76′ in FIGS. 11 and 12 and collectively form byproduct stream 76.

FIGS. 11 and 12 also schematically depict byproduct stream 76 being delivered to heating assembly 71 to be combusted with air, such as from air stream 90, to produce heated exhaust stream 88. In such an embodiment, heating assembly 71 will include any suitable structure for receiving and combusting stream 76 to generate heat therefrom. Illustrative, non-exclusive examples of suitable configurations for heating assembly 71 include burners, which may include an ignition source adapted to initiate combustion of stream 76 and/or any other fuel stream delivered thereto, and combustion catalysts in a suitable combustion region. As also shown in FIGS. 11 and 12, it is within the scope of the present disclosure that heating assembly 71 may, but is not required to, be adapted to receive a fuel stream 92 in addition to byproduct stream 76. In some embodiments, stream 92 may also be referred to as a supplemental fuel stream. Any suitable combustible fuel may be used in stream 92. Illustrative examples of suitable fuels for stream 92 include hydrogen gas, such as hydrogen gas produced by hydrogen-generation assembly 46, and/or any of the above-discussed carbon-containing feedstocks, including without limitation propane, natural gas, methane, and methanol. Although not required, the operation of heating assembly 71 may be regulated through a pressure swing adsorption purge controller, such as disclosed in U.S. patent application Ser. No. 11/058,307, which was filed on Feb. 14, 2005, and is entitled “Systems and Methods for Regulating Heating Assembly Operation Through Pressure Swing Adsorption Purge Control,” the complete disclosure of which has been incorporated by reference for all purposes.

As discussed in connection with FIG. 2, when PSA assembly 73 and heating assembly 71 are used in connection with a fuel processing system 64 that includes a hydrogen-producing region 70 that operates at elevated temperatures, the heating assembly may be adapted to heat at least region 70 with exhaust stream 88. For example, stream 88 may heat region 70 to a suitable temperature and/or to within a suitable temperature range, for producing hydrogen gas from one or more feed streams. As also discussed, steam and autothermal reforming reactions are illustrative examples of endothermic processes that may be used to produce mixed gas stream 74 from water and a carbon-containing feedstock, although other processes and/or feed stream components may additionally or alternatively be used to produce mixed gas stream 74. It is also within the scope of the present disclosure that the exhaust stream may be adapted to provide primary heating to heat a component of a hydrogen-production assembly, fuel cell system, or other implementation of assemblies 71 and 73.

In the illustrative embodiments shown in FIGS. 11 and 12, distribution assembly 104 includes a product manifold 150 and a purge manifold 152. Product manifold 150 is adapted to collect the streams of purified hydrogen gas that are withdrawn from the product ends 154 of the adsorbent beds and from which product hydrogen stream 42 is formed. These streams of purified hydrogen gas are indicated in FIGS. 11 and 12 at 42′. Purge manifold 152 is adapted to selectively deliver a purge gas, such as a portion of the purified hydrogen gas, to the adsorbed beds, such as to promote desorption of the adsorbed impurity gases and thereby regenerate the adsorbent contained therein. The purge gas streams are indicated at 156′ and may be collectively referred to as a purge gas stream 156. As indicated at 158, it is within the scope of the present disclosure that the product and purge manifolds may be in fluid communication with each other to selectively divert at least a portion of the purified hydrogen gas (or product hydrogen stream) to be used as purge stream 156. It is also within the scope of the present disclosure that one or more other gases from one or more other sources may additionally, or alternatively, form at least a portion of purge stream 156.

Although not required, FIGS. 11 and 12 illustrate at 168 that in some embodiments it may be desirable to fluidly connect the product manifold and/or fluid conduits for the product hydrogen stream with the fluid conduits for the byproduct stream. Such a fluid connection may be used to selectively divert at least a portion of the purified (or intended-to-be-purified) hydrogen gas to the heating assembly instead of the destination to which product hydrogen stream 42 otherwise is delivered. As discussed, examples of suitable destinations include hydrogen storage devices, fuel cell stacks, and hydrogen-consuming devices. Illustrative examples of situations in which the diversion of the product hydrogen stream to the heating assembly include if the destination is already receiving its maximum capacity of hydrogen gas, is out of service or otherwise unable to receive any or additional hydrogen gas, if an unacceptable concentration of one or more impurities are detected in the hydrogen gas, if it is necessary to shutdown the hydrogen-generation assembly and/or fuel cell system, if a portion of the product hydrogen stream is needed as a fuel stream for the heating assembly, etc.

In an implemented embodiment of PSA assembly 73, any suitable number, structure and construction of manifolds and fluid conduits for the fluid streams discussed herein may be utilized. Similarly, any suitable number and type of valves or other flow-regulating devices 170 and/or sensors or other property detectors 172 may be utilized, illustrative, non-exclusive examples of which are shown in FIGS. 11, 12, 14, and/or 15. For example, check valves 174, proportioning or other solenoid valves 176, pressure relief valves 178, variable orifice valves 180, and fixed orifices 182 are shown to illustrate non-exclusive examples of flow-regulating devices 170. Similarly, flow meters 190, pressure sensors 192, temperature sensors 194, and composition detectors 196 are shown to illustrate non-exclusive examples of property detectors 172. An illustrative example of a composition detector is a carbon monoxide detector 198, such as to detect the concentration, if any, of carbon monoxide in the purified hydrogen gas streams 42′ and/or product hydrogen stream 42.

While not required, it is within the scope of the present disclosure that the PSA assembly may include, be associated with, and/or be in communication with a controller that is adapted to control the operation of at least portions of the PSA assembly and/or an associated hydrogen-generation assembly and/or fuel cell system. A controller is schematically illustrated in FIGS. 2 and 11-12 and generally indicated at 132. Controller 132 may communicate with at least the flow-regulating devices and/or property detectors 172 via any suitable wired and/or wireless communication linkage, as schematically illustrated at 134. This communication may include one- or two-way communication and may include such communication signals as inputs and/or outputs corresponding to measured or computed values, command signals, status information, user inputs, values to be stored, threshold values, etc. As illustrative, non-exclusive examples, controller 132 may include one or more analog or digital circuits, logic units or processors for operating programs stored as software in memory, one or more discrete units in communication with each other, etc. Controller 132 may also regulate or control other portions of the hydrogen-generation assembly or fuel cell system and/or may be in communication with other controllers adapted to control the operation of the hydrogen-generation assembly and/or fuel cell system. Controller 132 is illustrated in FIGS. 11-12 as being implemented as a discrete unit. It may also be implemented as separate components or controllers. Such separate controllers, then, can communicate with each other and/or with other controllers present in system 22 and/or assembly 46 via any suitable communication linkages.

As discussed above, the degree of separation between hydrogen and the other gases from the mixed gas stream is affected by the pressure difference between the pressure of the mixed gas stream 74 delivered to the PSA assembly's beds and the pressure of the byproduct stream 76 exhausted from the PSA assembly beds. Thus, a greater pressure difference between the pressure of the mixed gas stream and the pressure of the byproduct stream may lead to greater separation or recovery of hydrogen from the other gases of the mixed gas stream. Therefore, for a determined, or selected mixed gas stream pressure, the degree of separation may be increased by reducing the pressure of the byproduct stream, such as by drawing an at least partial vacuum on the bed(s) via a vacuum system during at least part of the desorption and/or purge steps.

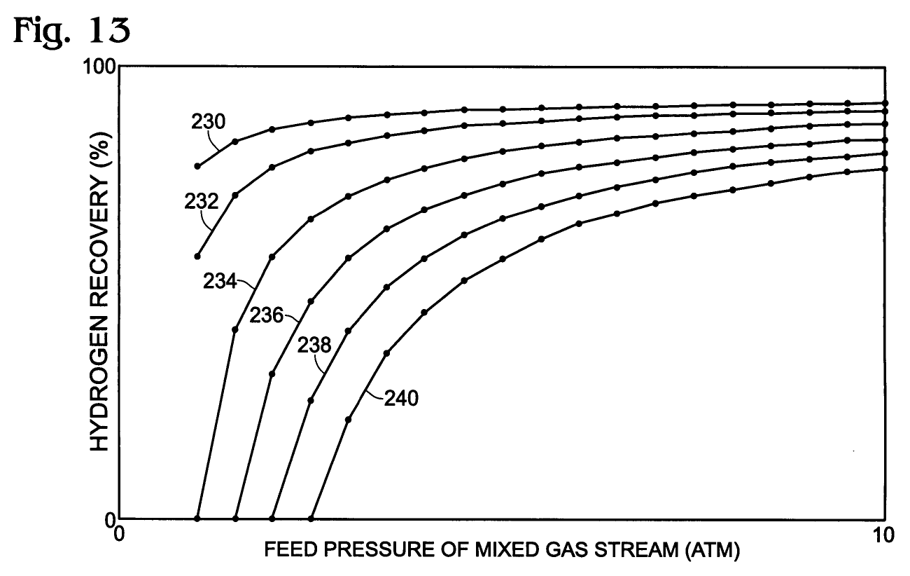

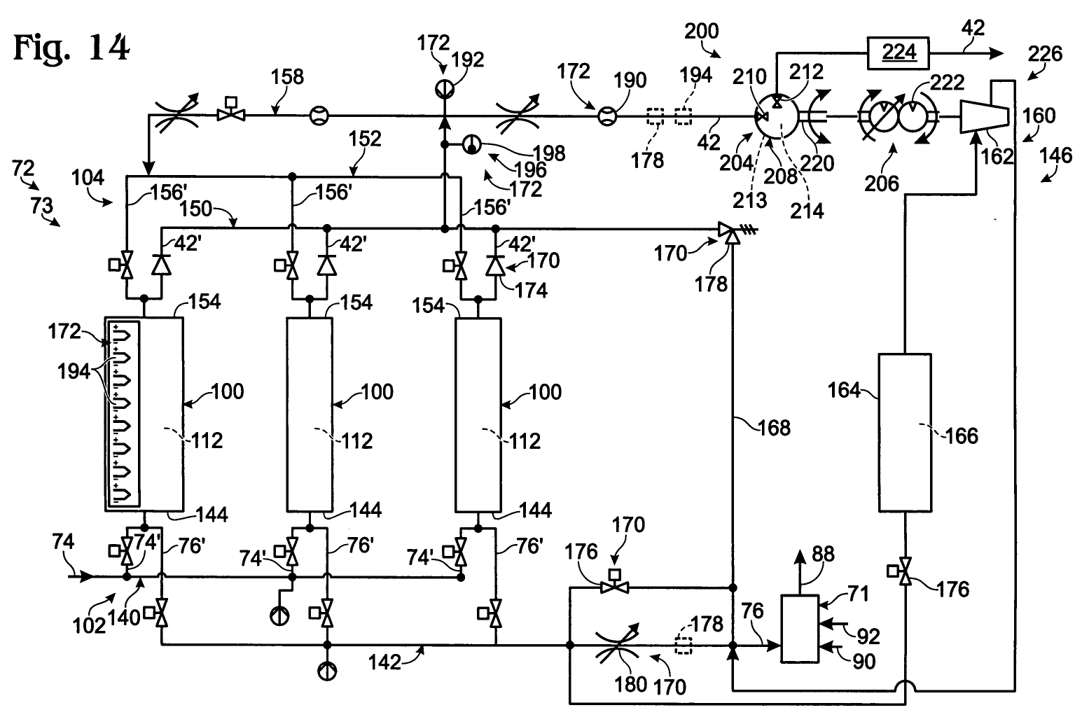

FIG. 13 presents a graph showing expected, or estimated, hydrogen recovery as a function of the (feed) pressure of the mixed gas stream delivered to the beds of a PSA assembly and the pressure of the byproduct stream removed from the beds of the PSA assembly during purging of the beds in a PSA assembly adapted to utilize one equalization prior to purging of the beds. Lines 230, 232, 234, 236, 238, and 240 represent a plurality of different pressures of the byproduct streams exhausted from the beds, with the lines representing 0.1 atm, 0.2 atm, 0.4 atm, 0.6 atm, 0.8 atm, and 1.0 atm purge pressures of the byproduct streams. As shown in FIG. 13, reductions in the pressure of the byproduct stream (moving from line 240 towards line 230) while maintaining the feed, or delivery, pressure of the mixed gas stream at least substantially constant leads to increases in hydrogen recovery, especially at lower feed pressures of the mixed gas stream. Additionally, increases in the feed pressure of the mixed gas stream (left to right in FIG. 13) while maintaining the purge pressure of the byproduct stream at least substantially constant lead to increases in hydrogen recovery. In the illustrated graph, it can be seen that PSA assemblies that are adapted to receive mixed gas streams having pressures of 10 atm or less may increase the hydrogen recovery of the system (percentage of hydrogen gas in the mixed gas stream that is separated into the product hydrogen stream) by reducing the pressure at which the byproduct stream is withdrawn therefrom. The relative effect of this increase in hydrogen recovery may be greater as the feed pressure of the mixed gas stream decreases, such as when the PSA assemblies are adapted to operate at pressures less than 8 atm, less than 6 atm, etc., although it is within the scope of the present disclosure that greater or lower pressures may be used.

Although not required to all embodiments, PSA assemblies 73 according to the present disclosure may include, or be in communication with, a vacuum system that is configured to draw at least a partial vacuum on one or more beds of the PSA assembly to assist in the desorption and/or purging steps of the PSA process. For example, illustrative examples of PSA assemblies 73 that include a vacuum system are shown in FIGS. 11 and 12, in which the vacuum system is schematically illustrated at 160. Vacuum system 160 and purge manifold 152 (and optionally one or more external sources of purge gas) may be referred to as a purge system 146 for PSA assembly 73. Similarly, hydrogen-generation assemblies 46 and/or fuel cell systems 22 according to the present disclosure may be described as including a pressure swing adsorption assembly, which is adapted to separate the mixed gas stream into product hydrogen and byproduct streams, and a vacuum system that is adapted to selectively apply a vacuum to at least one of the beds of the PSA assembly to assist in the desorption and/or purging steps of the PSA process.

In the illustrative examples shown in FIGS. 11 and 12, vacuum system 160 includes a vacuum pump 162, which includes any suitable device(s) and/or structure(s) configured to generate a purging vacuum and/or draw at least a partial vacuum on one or more beds of the PSA assembly to assist in one or more portions of the desorption and/or purging steps of the PSA process. As illustrated in FIG. 1, inlet 161 of the vacuum pump is fluidly connected to exhaust manifold 142, while an outlet 163 is fluidly connected to at least one fluid conduit for byproduct stream 76. The vacuum system also may (but is not required to) include, as indicated at 164 in FIG. 12, a vacuum storage chamber, or vacuum supply, which includes any suitable device(s) and/or structure(s) configured to store at least a portion of the vacuum drawn by vacuum pump 162. The stored vacuum may be referred to as the purging vacuum supply at 166, which is configured to be used during at least one or more portions of the desorption and/or purge steps of the PSA process. Vacuum system 160 may include additional components that are not specifically illustrated in the schematic figures, such as heat exchangers, sensors, controllers, flow-regulating devices, and the like.

Expressed in slightly different terms, the purge system is adapted to generate an at least partial vacuum, which may be referred to as a purging vacuum, that is selectively applied to at least one of the beds of the PSA assembly during the purging and/or desorption steps of the PSA process. In the illustrative example shown in FIG. 11, the vacuum system is adapted to apply any generated vacuum directly to the one or more beds of the PSA assembly. In FIG. 12, the vacuum system is adapted to generate and at least temporarily store any generated vacuum in a separate storage chamber, with this stored vacuum being selectively applied to the beds of the PSA assembly to assist in the desorption and/or purging steps of the PSA process.

The vacuum system may be powered, or driven, by any suitable method(s) and/or system(s). Although not required, FIGS. 11 and 12 illustrate that vacuum system 160 may be adapted to be powered, at least in part, by recovered energy 202 from energy recovery assembly 200. For example, energy recovery assembly 200 may include a gas motor, or other suitable energy recovery device, 204 that is adapted to receive product hydrogen stream 42 and generate mechanical energy (i.e., as indicated as recovered energy 202 in FIGS. 11 and 12) through the selective reduction in the pressure of this stream, such as to a suitable pressure for use of the product hydrogen stream as a fuel for a fuel cell stack. In some embodiments, vacuum system 160 may be completely powered by energy recovery assembly 200. Alternatively, or additionally, the vacuum system may be powered electrically through the power produced by the fuel cell stack, a battery or other energy-storage device, a utility grid, any suitable power source, such as a wind-powered energy source, a solar-powered energy source, a water-powered energy source, etc.

Vacuum system 160 and/or energy-recovery assembly 200 may be configured to be optional, or supplementary, component(s) of purge system 146 and hydrogen-generating and/or fuel cell systems containing the same. The purge system is thus configured to suitably purge one or more of adsorbent beds 100 of PSA assembly 73 regardless of the amount of purging vacuum, if any, generated by vacuum pump 162 and/or stored in purging vacuum supply 164. By “regardless of,” it is meant that the purge system is configured to suitably purge the adsorbent beds whether or not the vacuum system is assisting in the desorption and/or purge steps of the PSA process. When the vacuum system is generating a sufficient vacuum supply to assist in one or both of these steps, then the PSA assembly may be able to increase the amount of hydrogen gas present in the product hydrogen stream, as compared to the amount that would be present without vacuum-assisted desorption/purging. However, the product hydrogen stream produced without this vacuum-assistance should still be of sufficient quantity and purity for use as a reasonable fuel stream for the fuel cell stack.

Accordingly, the PSA assemblies, hydrogen-generation assemblies, and/or fuel cell systems that include energy-recovery assemblies and/or vacuum systems according to the present disclosure may be configured to operate and suitably purify and/or generate an electric current from the produced hydrogen gas regardless of whether the vacuum system and/or energy-recovery assembly are operating. Therefore, these components may be considered to be optional performance-enhancing or performance-boosting components because they may increase the product hydrogen recovered when they are operating, but they will not interfere with the operation of the fuel cell (or other) system when they are not operating. In other words, it is within the scope of the present disclosure that the vacuum system and energy-recovery assembly are not required to be operational for PSA assembly 73 to operate to suitably separate the mixed gas stream into the product hydrogen and byproduct streams. Accordingly, purge system 146 may be adapted to suitably purge the adsorbent beds of the PSA assembly regardless of whether the vacuum system is generating a vacuum and/or regardless of whether the vacuum supply chamber includes a vacuum supply and/or whether energy-recovery assembly 200 is generating mechanical energy from the product hydrogen stream to drive the operation of the vacuum system.

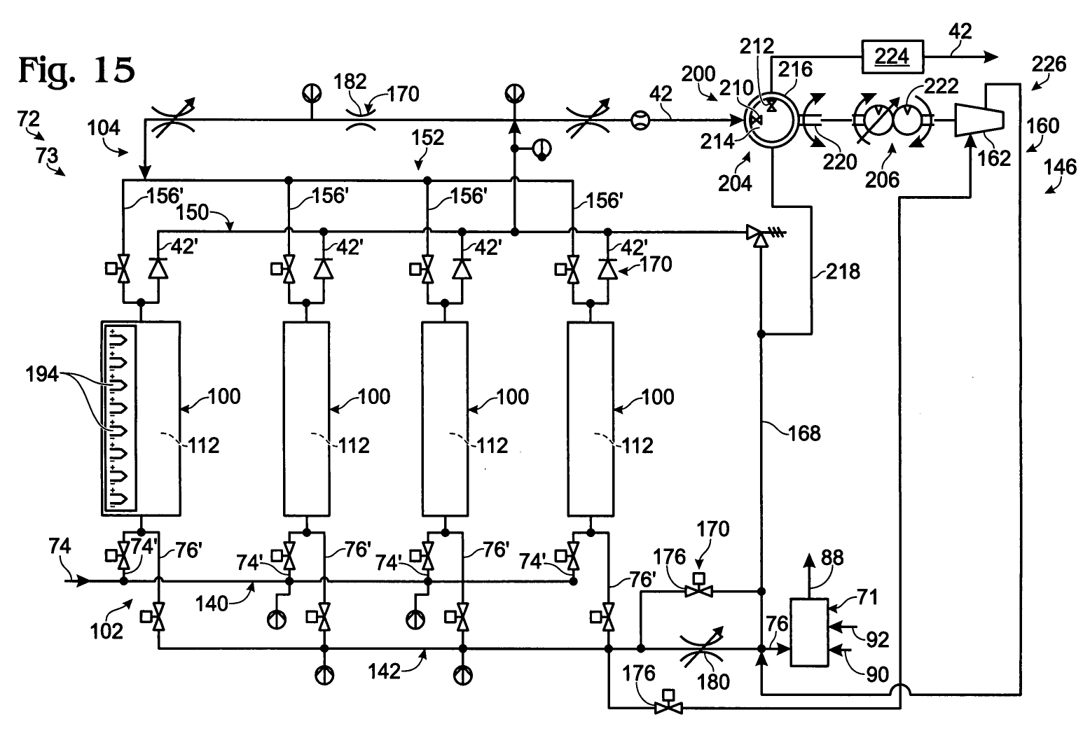

FIGS. 14 and 15 provide additional, somewhat less schematic examples, of illustrative separation assemblies 72 that include a PSA assembly 73 with an energy recovery assembly 200 and a vacuum system 160. As illustrated, the energy recovery assembly includes a gas motor 204 and a mechanical coupling 206. Gas motor 204 includes any suitable device(s) and/or structure(s) configured to recover, or generate, mechanical energy from product hydrogen stream 42. Mechanical coupling 206 includes any suitable device(s) and/or structure(s) configured to apply the recovered mechanical energy to one or more components of energy producing system 22, such as to partially or completely drive or power the operation of the component(s). As discussed, an illustrative, non-exclusive example of such a component is a vacuum pump 162 of vacuum system 160.

Gas motor 204 may be selectively configured among, or between, a plurality of operating states. Those operating states include at least an energy recovering operating state, in which the gas motor is recovering mechanical energy from the product hydrogen stream, and an idle operating state, in which the gas motor is not recovering mechanical energy from the product hydrogen stream. It is within the scope of the disclosure that gas motor 204 may be selectively configured among additional defined operating states, including a transition operating state in which the gas motor is transitioning between the energy recovering operating state and the idle operating state.

The gas motor may be configured to operate among the plurality of operating states based, or responsive, at least in part, on one or more PSA process parameters, such as the pressure of the product hydrogen stream. For example, the gas motor may be configured to transition (or self-start) from the idle operating state to the energy recovering operating state responsive, at least in part, to when the pressure of the product hydrogen stream exceeds a threshold pressure. The threshold pressure may be any suitable predetermined pressure. The threshold pressure may be inherent in the energy-recovery system, such as the pressure required to drive the gas motor or other energy recovery device. It is also within the scope of the present disclosure that the threshold pressure may relate to one or more process goals, such as optimizing when the gas motor is in the energy recovering operating state, ensuring that the product hydrogen stream exhausted from the gas motor or other energy recovery device retains sufficient pressure for use as a fuel for fuel cell stack 24, etc. In some embodiments it may be desirable to utilize a threshold pressure that is at least 60 psi, at least 65 psi, in the range of 60-75 psi, etc. It is within the scope of the disclosure, however, that threshold pressures greater than or less than these illustrative threshold pressures may be used.

The gas motor may in addition, or alternatively, be configured to transition from the idle operating state to the energy recovering operating state responsive, at least in part, to when the pressure of the product hydrogen stream is within a specified pressure range. The specified pressure range may be any suitable predetermined pressure and may relate to one or more process goals, illustrative, non-exclusive examples of which are discussed above. For example, the specified pressure range may be 65 to 120 psi because any pressure less than that range may be too low for efficient use and any pressure greater than that range may be beyond the design of industrial pneumatics. It is within the scope of the disclosure, however, that other specified pressure ranges may be used.

Additionally, or alternatively, the gas motor may be configured to transition from the energy recovering operating state to the idle operating state responsive, at least in part, to when the pressure of the product hydrogen stream falls below a lower threshold pressure, exceeds an upper threshold pressure, and/or falls outside a specified pressure range. The lower and upper threshold pressures may be any suitable predetermined pressures and may relate to one or more process goals. For example, the lower threshold pressure may be set at 65 psi and the upper threshold pressure may be set at 120 psi for at least the reasons discussed in the illustrative examples above. It is within the scope of the disclosure, however, that lower threshold pressures greater than or less than 65 psi may be used. Additionally, it is within the scope of the disclosure that upper threshold pressures less than or greater than 120 psi may be used.

It is within the scope of the disclosure that the gas motor be configured to transition between the plurality of operating states based, at least in part, on other PSA process parameters, such as temperature of the product hydrogen stream, pressure of the mixed gas stream, the vacuum supply, the current stage of the PSA process, etc. Additionally, it is within the scope of the disclosure that the gas motor be configured to transition between the plurality of operating states based, at least in part, on process parameters other than those associated with the PSA process, such as process parameters associated with the fuel processing system and/or the fuel cell stack.

Illustrative (non-exclusive) examples of gas motors are shown in FIGS. 14 and 15. In the illustrated example shown in FIG. 14, gas motor 204 includes a housing 208 having an inlet port 210 and an outlet port 212. The housing is in fluid communication with product hydrogen stream 42 and is sealed and/or otherwise configured to prevent the product hydrogen stream from leaking or from passing from within the housing to external the housing other than through inlet port 210 and/or outlet port 212. For example, housing 208 may include one or more gas-tight seals 213 configured to prevent the product hydrogen stream from passing from within the housing to external the housing other than through at least one of the inlet and outlet ports.

Gas motor 204 includes a working portion 214 disposed between the inlet and outlet ports, where the inlet and outlet ports and the working portion are in fluid communication with the product hydrogen stream, as shown in FIGS. 14 and 15. Working portion 214 schematically represents the component(s) of the gas motor that is/are adapted to recover, or generate, mechanical energy from the product hydrogen stream. In FIG. 15, the gas motor is shown including a containment portion 216 that at least partially surrounds the working portion and/or is configured to contain at least a portion of the product hydrogen stream that leaks and/or flows from the working portion to external the working portion other than through at least one of the inlet and outlet ports. The containment portion may include any suitable device(s) and/or structure(s). For example, containment portion 216 may include a jacket, covering, and/or casing that, at least partially, surrounds the working portion and captures at least some of the product hydrogen stream. In some embodiments, the containment portion may be in fluid communication with an exhaust line 218 of PSA assembly 73, while in some embodiments, the exhaust line is in fluid communication with heating assembly 71.

An illustrative, non-exclusive example of a suitable gas motor is a piston-driven air motor that has been sealed to prevent hydrogen gas from leaking. Illustrative examples include the high purity series of air motors from Dynatork Air Motors. It is within the scope of the disclosure, however, that gas motor 204 may include other devices, such as expander(s) and the like that are configured to recover or otherwise extract or produce mechanical energy from product hydrogen stream 42.

Illustrative examples of mechanical couplings are shown in FIGS. 14 and 15. Mechanical coupling 206 includes a shaft 220 that gas motor 204 is configured to rotate when the gas motor is in the energy recovering operating state. The shaft is coupled to a suitable mechanical arrangement of gears, pulleys, and the like, as indicated at 222, and vacuum pump 162 is coupled to that mechanical arrangement. Mechanical arrangement 222 may be configured to maximize power transfer (speed and/or torque) between gas motor 204 and vacuum pump 162. Alternatively, shaft 220 may be a common shaft for gas motor 204 and vacuum pump 162 without the mechanical arrangement. Gas motor 204, mechanical coupling 206, and vacuum pump 162 may be referred to as energy recovery and reuse assembly at 226.

Although gas motor 204 is shown to be mechanically connected to vacuum pump 162 via mechanical coupling 206, it is within the scope of the disclosure that gas motor 204 may be connected to other components of energy producing system 22 in addition to, or as an alternative to, the vacuum pump. For example, it is within the scope of the disclosure that gas motor 204 may be mechanically connected to natural gas or other compressor(s), carbon-containing feed compressor(s), cathode blower(s), anode recirculator(s), and/or fuel cell coolant pump(s) of the energy producing system. It may be preferable to mechanically connect the gas motor to the largest balance-of-plant (BOP) loads of energy producing system 22 and thus configure the gas motor to apply recovered energy to those loads. Additionally, or alternatively, gas motor 204 may be mechanically connected to one or more components outside of energy-producing system 22, such as energy-consuming device 52.

As an illustrative example of another illustrative embodiment of energy recovery and reuse assembly 226, gas motor 204 may be mechanically connected to a mixed gas stream feed compressor, which is configured to increase the pressure of the hydrogen-containing mixed gas stream that is delivered to the PSA assembly for purification. That increase of pressure provides a greater pressure difference between the pressure of the mixed gas stream and the pressure of the byproduct stream, which may lead to a greater degree separation or recovery of hydrogen from the other gases of the mixed gas stream. Alternatively, the gas motor may be mechanically connected to both the vacuum pump and the mixed gas stream feed compressor to potentially provide an even greater pressure difference between the pressure of the mixed gas stream and the pressure of the byproduct stream, which may lead to an even greater degree of separation or recovery of hydrogen from the other gases of the mixed gas stream.

As illustrated in FIGS. 14 and 15, the energy recovery assembly may include (but is not required in all embodiments to include) a pressure regulator 224, which includes any suitable device(s) and/or structure(s) configured to regulate the pressure of the product hydrogen stream downstream of gas motor 204 to ensure that the product hydrogen stream is at an appropriate pressure for receipt and/or use by component(s) and/or system(s) downstream of the gas motor, such as a fuel cell stack. The pressure regulator may be configured to regulate the pressure of the product hydrogen stream regardless, or independent, of the operational state of gas motor 204. An illustrative example of the pressures regulated by the pressure regulator includes regulating a product hydrogen stream pressure of 60-70 psi down to (approximately) 5 psi for use in a fuel cell stack. It is within the scope of the disclosure, however, that the pressure regulator may be configured to regulate product hydrogen streams with pressures greater than or less than 60-70 psi. Additionally, it is within the scope of the disclosure that the pressure regulator may be configured to reduce the pressure of the product hydrogen stream to pressures greater than or less than 5 psi.

It should be understood that the energy-recovery assembly and vacuum systems described herein are optional, or supplementary, components of the hydrogen-generation assembly. The operation (or non-operation) of these components, including gas motor 204, is thus independent, or regardless, of the ability of the PSA (or other separation) assembly to produce the product hydrogen stream. Additionally, pressure regulator 224 is configured to regulate the pressure of the product hydrogen stream independent, or regardless, of the operating state of the gas motor. Gas motor 204 is thus not required for the hydrogen-generation assembly to produce hydrogen or to regulate the pressure of the hydrogen. The energy recovery and reuse assembly and/or gas motor may therefore be considered an optional operational enhancement, performance enhancing, or performance-boosting component because it recovers energy when operating but is not required by the hydrogen-generation assembly to produce the product hydrogen stream and/or to regulate the pressure of the product hydrogen stream.

In FIGS. 11-12 and 14-15, a plurality of optional temperature sensors 194 are shown associated with one of the illustrated adsorbent beds. It is within the scope of the present disclosure that each or none of the beds may include one or more temperature sensors adapted to detect one or more temperatures associated with the adsorbent bed, the adsorbent in the bed, the adsorbent region of the bed, the gas flowing through the bed, etc. Although not required, PSA assemblies 73 according to the present disclosure may include a temperature-based breakthrough detection system, such as disclosed in U.S. patent application Ser. No. 11/055,843, which was filed on Feb. 10, 2005, is entitled “Temperature-Based Breakthrough Detection and Pressure Swing Adsorption Systems and Fuel Processing Systems Including the Same,” and the complete disclosure of which has been incorporated by reference for all purposes.

Although discussed herein in the context of a PSA assembly for purifying hydrogen gas, it is within the scope of the present disclosure that the energy recovery assemblies disclosed herein, as well as the methods of operating the same, may be used in other applications.

### INDUSTRIAL APPLICABILITY

The pressure swing adsorption assemblies and hydrogen-generation and/or fuel cell systems including the same are applicable in the gas generation and fuel cell fields, including such fields in which hydrogen gas is generated, purified, and/or consumed to produce an electric current.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A hydrogen-generation assembly, comprising:
a fuel processing system including at least one hydrogen-producing region adapted to receive at least one feed stream and to produce a mixed gas stream containing hydrogen gas and other gases therefrom;
a pressure swing adsorption assembly including a plurality of adsorbent beds and being adapted to receive the mixed gas stream and to produce a product hydrogen stream therefrom, wherein the product hydrogen stream has a pressure, contains at least substantially pure hydrogen gas and has a reduced concentration of the other gases than the mixed gas stream, and further wherein the pressure swing adsorption assembly is further adapted to produce a byproduct stream containing at least a substantial portion of the other gases;
an energy recovery assembly in fluid communication with the product hydrogen stream, wherein the energy recovery assembly is configured to recover mechanical energy from the product hydrogen stream and to apply the recovered mechanical energy to one or more components of at least the hydrogen-generation assembly; and
a vacuum system adapted to selectively generate and apply a vacuum to the plurality of adsorbent beds; wherein the vacuum system is adapted to be at least partially powered by the recovered mechanical energy.

2. The hydrogen-generation assembly of claim 1, wherein the energy recovery assembly includes a gas motor configured to recover mechanical energy from the product hydrogen stream.

3. The hydrogen-generation assembly of claim 2, wherein the pressure swing adsorption assembly is configured to produce the product hydrogen stream regardless of the operating state of the gas motor.

4. The hydrogen-generation assembly of claim 2, wherein the gas motor is configured to transition between a plurality of operating states based, at least in part, on the pressure of the product hydrogen stream, and further wherein the plurality of operating states include a first state in which the gas motor is recovering mechanical energy from the product hydrogen stream, and a second state in which the gas motor is not recovering mechanical energy from the product hydrogen stream.

5. The hydrogen-generation assembly of claim 4, wherein the gas motor is configured to transition from the second state to the first state responsive, at least in part, to when the pressure of the product hydrogen stream exceeds a threshold pressure.

6. The hydrogen-generation assembly of claim 4, wherein the gas motor is configured to transition from the first state to the second state responsive, at least in part, to when the pressure of the product hydrogen stream falls below a threshold pressure.

7. The hydrogen-generation assembly of claim 4, further comprising a pressure regulator in fluid communication with the product hydrogen stream downstream of the gas motor, wherein the pressure regulator is configured to regulate the pressure of the product hydrogen stream regardless of the operating state of the gas motor.

8. The hydrogen-generation assembly of claim 2, wherein the gas motor includes a housing having an inlet port and an outlet port, wherein the housing is in fluid communication with the product hydrogen stream and is configured to prevent the product hydrogen stream from passing from within the housing to external the housing other than through at least one of the inlet and outlet ports.

9. The hydrogen-generation assembly of claim 2, wherein the gas motor includes an inlet port, an outlet port, and a working portion disposed between the inlet and outlet ports, wherein the inlet and outlet ports and the working portion are in fluid communication with the product hydrogen stream, wherein the gas motor further includes a containment portion at least partially surrounding the working portion, and wherein the containment portion is configured to contain at least a portion of the product hydrogen stream that flows from the working portion to external the working portion other than through at least one of the inlet and outlet ports.

10. The hydrogen-generation assembly of claim 9, wherein the containment portion is in fluid communication with an exhaust conduit of the pressure swing adsorption assembly.

11. The hydrogen-generation assembly of claim 10, wherein the exhaust conduit is in fluid communication with a heating assembly adapted to combust gases delivered thereto through the exhaust conduit.

12. The hydrogen-generation assembly of claim 1, wherein the pressure swing adsorption assembly includes a purge system configured to selectively purge the plurality of adsorbent beds, and further wherein the purge system is in communication with the vacuum system and adapted to selectively utilize the vacuum generated thereby during purging of the plurality of adsorbent beds.

13. The hydrogen-generation assembly of claim 12, wherein the vacuum system includes a vacuum pump adapted to be driven by the recovered mechanical energy from the energy recovery assembly.

14. The hydrogen-generation assembly of claim 13, wherein the purge system is configured to selectively purge the plurality of adsorbent beds regardless of the purging vacuum generated by the vacuum pump.

15. The hydrogen-generation assembly of claim 13, wherein the purge system includes a vacuum supply chamber adapted to receive and at least temporarily store the vacuum generated by the vacuum system prior to the vacuum being selectively applied to the plurality of adsorbent beds via the purge system.

16. The hydrogen-generation assembly of claim 15, wherein the purge system is configured to selectively purge the plurality of adsorbent beds regardless of the amount of purging vacuum stored in the vacuum supply.

17. The hydrogen-generation assembly of claim 1, wherein the hydrogen-producing region includes a steam reforming region configured to produce the mixed gas stream from water and a carbon-containing feedstock.

18. The hydrogen-generation assembly of claim 1, wherein the hydrogen-producing region includes at least one of an autothermal reforming region or a partial oxidation region.

19. The hydrogen-generation assembly of claim 1, in combination with a fuel cell stack adapted to receive at least a portion of the product hydrogen stream.

20. The hydrogen-generation assembly of claim 1, wherein the pressure swing adsorption assembly includes a rotary pressure swing adsorption device.

21. A hydrogen-generation assembly, comprising:
a fuel processing system including at least one hydrogen-producing region adapted to receive at least one feed stream and to produce a mixed gas stream containing hydrogen gas and other gases therefrom;
a pressure swing adsorption assembly adapted to receive the mixed gas stream and to produce a product hydrogen stream containing at least substantially pure hydrogen gas and having a reduced concentration of the other gases than the mixed gas stream, wherein the pressure swing adsorption assembly is further adapted to produce a byproduct stream containing at least a substantial portion of the other gases, wherein the pressure swing adsorption assembly includes a plurality of adsorbent beds in which the mixed gas stream is separated into streams forming the product hydrogen stream and the byproduct stream, and further wherein the pressure swing adsorption assembly includes a purge system adapted to selectively purge the plurality of adsorbent beds to form exhaust streams that form the byproduct stream;
a vacuum system including a vacuum pump configured to generate a purging vacuum supply, wherein the purge system is adapted to selectively apply the purging vacuum supply to one or more of the plurality of adsorbent beds;
a gas motor in fluid communication with the product hydrogen stream, wherein the gas motor is configured to recover mechanical energy from the product hydrogen stream and to apply the recovered mechanical energy to power at least the vacuum pump; and
a fuel cell stack adapted to receive at least a portion of the product hydrogen stream.

22. The hydrogen-generation assembly of claim 21, wherein the gas motor is configured to transition between a plurality of operating states based, at least in part, on the pressure of the product hydrogen stream, and further wherein the plurality of operating states includes a first state in which the gas motor is recovering mechanical energy, and a second state in which the gas motor is not recovering mechanical energy.

23. The hydrogen-generation assembly of claim 22, wherein the pressure swing adsorption assembly is configured to produce the product hydrogen stream regardless of the operating state of the gas motor.

24. The hydrogen-generation assembly of claim 22, wherein the gas motor is configured to transition from the second state to the first state responsive, at least in part, to when the pressure of the product hydrogen stream exceeds a threshold pressure, and wherein the gas motor is configured to transition from the first state to the second state responsive, at least in part, to when the pressure of the product hydrogen stream falls below a threshold pressure.

25. The hydrogen-generation assembly of claim 22, further comprising a pressure regulator in fluid communication with the product hydrogen stream downstream of the gas motor, wherein the pressure regulator is configured to regulate the pressure of the product hydrogen stream regardless of the operating state of the gas motor.

26. A method for recovering and reusing mechanical energy from a product hydrogen stream of a pressure swing adsorption assembly, comprising:
producing a product hydrogen stream from a mixed gas stream containing hydrogen gas and other gases, wherein the producing utilizes a pressure swing adsorption assembly, and further wherein the product hydrogen stream has a pressure;
recovering mechanical energy from the product hydrogen stream;
applying the mechanical energy to one or more components of at least one of the pressure swing adsorption assembly and a fuel cell stack in fluid communication with the pressure swing adsorption assembly; and
delivering at least a portion of the product hydrogen stream to a fuel cell stack.

27. The method of claim 26, wherein recovering mechanical energy selectively occurs at least a portion of the time when the pressure of the product hydrogen stream exceeds a threshold pressure, and does not occur at least a portion of the time when the pressure of the product hydrogen stream does not exceed the threshold pressure, and further wherein the producing and delivering occurs regardless of whether the recovering and applying occurs.

28. The method of claim 26, wherein the one or more components include a vacuum pump configured to generate at least one of a purging vacuum and a purging vacuum supply, and further wherein the method includes applying the at least one of a purging vacuum and a purging vacuum supply to one or more adsorbent beds of the pressure swing adsorption assembly.

29. The method of claim 26, further comprising regulating the pressure of the product hydrogen stream prior to the delivering and regardless of whether or not the recovering and applying of the mechanical energy occurs.
